(19) United States
(12) Patent Application Publication
(10) Pub. No.: US 2017/0236165 A1
(43) Pub. Date: Aug. 17, 2017

(54) TECHNIQUES FOR TARGETED REAL-TIME BIDDING ON ON-LINE ADVERTISEMENTS

(71) Applicant: Sizmek Technologies Ltd., Herzliya (IL)

(72) Inventors: Jonathan SCHLER, Petach Tikwa (IL); Kobi SHEMER, Netanya (IL)

(73) Assignee: Sizmek Technologies Ltd., Herzliya (IL)

(21) Appl. No.: 15/044,215

(22) Filed: Feb. 16, 2016

(51) Int. Cl. G06Q 30/02; H04L 29/08

(52) U.S. Cl. CPC G06Q 30/0275; H04L 67/02; G06Q 30/0277

(57) ABSTRACT

A method and system for allowing targeted bidding for online advertisements are provided. The method includes causing an emulation of an emulated bidder for bidding on a placement of an advertisement in a webpage; receiving, from the emulated bidder, a current bid identifier associated with the placement; causing, in real-time, a comparison of the current bid identifier to at least one stored bid identifier, wherein each stored bid identifier is associated with stored target information; receiving target information of the webpage, wherein the received target information is identified based on the comparison, wherein the received target information is related to targeted advertising for the webpage; and sending the target information of the webpage to at least one other bidder that is bidding on the placement.

### TECHNICAL FIELD

The present disclosure relates on-line advertising systems, and more specifically, to targeted real-time bidding for placement of on-line advertisements.

### BACKGROUND

Websites, including commercial, corporate, and personal websites, publish advertisements on their webpages. Such advertisements are typically published in the form of banners that may be comprised of static or rich media content. Banners that include rich media content are displayed as a combination of text, audio, still images, animation, video, and interactivity content for forms.

Advertisement (Ad) serving relates to the placement of advertisements on webpages and/or within multimedia content. In addition to placing advertisements, advertisement-serving systems also select which advertisements should be served to websites based on advertising campaign preferences, count impressions, click counts on advertisements, and monitored progress of different advertising campaigns. An advertisement serving system is typically realized as a server backed by a database server that stores advertisements.

Typically, selection of which advertisement to serve on which webpages is determined through an auction process. In such a process, advertisers bid for allocation and serving of their online advertisements in connection with serving opportunities. In online advertising, an auction process is typically realized by means of real-time bidding (RTB) system.

A RTB system is the means for buying and selling an advertising inventory on a per-impression basis. A RTB system allows advertising buyers to bid on an impression and, if the bid is won, the buyer's advertisement is instantly displayed on a publisher's website. Real-time bidding is distinguishable from static auctions by how it is a per-impression way of bidding, whereas static auctions are groups of up to several thousand impressions.

FIG. 1 shows an exemplary and non-limiting schematic diagram of a system 100 illustrating a typical advertisement bidding process. The system 100 includes a user device 110, a publisher server 120, an advertisement-serving (ad-serving) system 130, a RTB server (ad-exchange) 140, a plurality of bidders 150-1 through 150-n (hereinafter referred to individually as a bidder 150 and collectively as bidders 150, merely for simplicity purposes), communicatively connected to a network, such as the World Wide Web (WWW). The publisher server 120 hosts a website accessible by the user device 110. The webpages provided by publisher server 120 may include advertisements served by the ad-serving system 130. Each bidder 150 may be a computing device operated by an advertising entity or a representative thereof such as, e.g., a demand-side platform (DSP).

A typical transaction begins with a user of a user device 110 visiting a website hosted by the publisher server 120. The request (e.g., HTTP request) from the user device 110 would trigger a call for from the publisher server 120 to the RTB server 140 for a bid request for an ad-impression that includes a URL of the visited request. Typically, the request from a bid from the publisher server 120 includes a masked URL or fake URL that is not related to the real web page visited by the device 110. For example, a user visiting a web-page on “www.cnn.com”, can be presented as “ad.exchange.publisher1.com”.

In response, the RTB server 140 solicits bids for a requested advertisement from the bidders 150. Such a bid request may include only a bid-identification (ID). In such a case, bid requests may include a price tag, the mask URL, and/or some content categorizes related to the content of the visited web-page to place the ad. However, it should be noted that the bid request typically does not include the real URL of the visited web-page. In some embodiments, the bid request may include the real URL of the visited web-page. The bidders 150 may place bids for a requested advertisement during an auction, and a winner (e.g., the highest bidder among the bidders 150) in the auction may have its advertisement placed in the webpage. To this end, the winning bidder is reported by the RTB server 140 to the ad-serving system 130, which serves an advertisement of the winning bidder directly to user device 110. Typically, the advertisement is served within an iFrame tag, a script tag, or another enclosed environment within a webpage.

The ad-serving system 130 and the RTB server 140 handle multiple campaigns, and each campaign may include multiple advertisements to be served at different webpages. The bidding process is typically performed per ad-impression per advertisement slot on a webpage. Thus, the real-time bidding process is an automated process. The advertisers 150 autonomously bid based on an ad-impression based on a set of predefined criteria mostly tied to monetary parameters, such as budget and a price range. As such, advertisers 150 and their agents do not and cannot check the validity of each ad-impression to be served.

One of the disadvantages of the process for serving an advertisement, as discussed above, is that the RTB server 140 typically does not provide the bidders 150 with the real URL of the visit webpage. As a result, bidders (i.e., bidders 150) cannot provide targeted bidding on a specific URL. The inability of the bidders 150 to know what is the URL they bid on (and won), limits the advertisers to perform true and accurate verifications of served advertisements. Further, campaigns cannot be optimized to achieve optimal performances, as the bidders 150 do not take bidding decisions based on critical information, such as the real URL of a webpage, to display the advertisements.

It would therefore be advantageous to provide a solution that would overcome the deficiencies noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain exemplary embodiments disclosed herein include a method for allowing targeted bidding for online advertisements. The method comprises causing an emulation of an emulated bidder for bidding on a placement of an advertisement in a webpage; receiving, from the emulated bidder, a current bid identifier associated with the placement; causing, in real-time, a comparison of the current bid identifier to at least one stored bid identifier, wherein each stored bid identifier is associated with stored target information; receiving target information of the webpage, wherein the received target information is identified based on the comparison, wherein the received target information is related to targeted advertising for the webpage; and sending the target information of the webpage to at least one other bidder that is bidding on the placement.

Certain exemplary embodiments disclosed herein also include a system for allowing targeted bidding for online advertisements. The system comprises a processing unit; and a memory, the memory containing instructions that, when executed by the processing unit, configure the system to: cause an emulation of an emulated bidder for bidding on a placement of an advertisement in a webpage; receive, from the emulated bidder, a current bid identifier associated with the placement; cause, in real-time, a comparison of the current bid identifier to at least one stored bid identifier, wherein each stored bid identifier is associated with stored target information; receive target information of the webpage, wherein the received target information is identified based on the comparison, wherein the received target information is related to targeted advertising for the webpage; and send the target information of the webpage to at least one other bidder that is bidding on the placement.

Certain exemplary embodiments disclosed herein also include a method for verification of targeted bidding for online advertisements. The method comprises identifying target information of a webpage based on a plurality bidders bidding on a placement of an online advertisement in the webpage; receiving winning bidder information identifying at least a winning bidder of the a plurality of bidders and the current bid identifier; correlating the winning bidder information with the target information; and generating a verification report based on the correlated information, wherein the verification report indicates at least if the online advertisement has been placed in the webpage on which the bid was placed.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a diagram illustrating a conventional system for bidding on a placement of an ad.

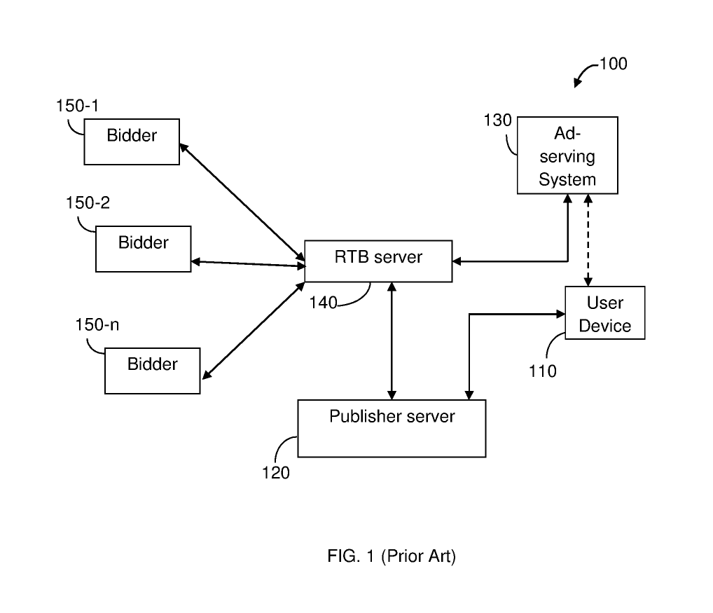

FIG. 2 is a diagram of a system for bidding on a placement of an ad utilized to describe the various embodiments.

FIG. 3 is a flowchart of a method for allowing targeted bidding on on-line ads according to one embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

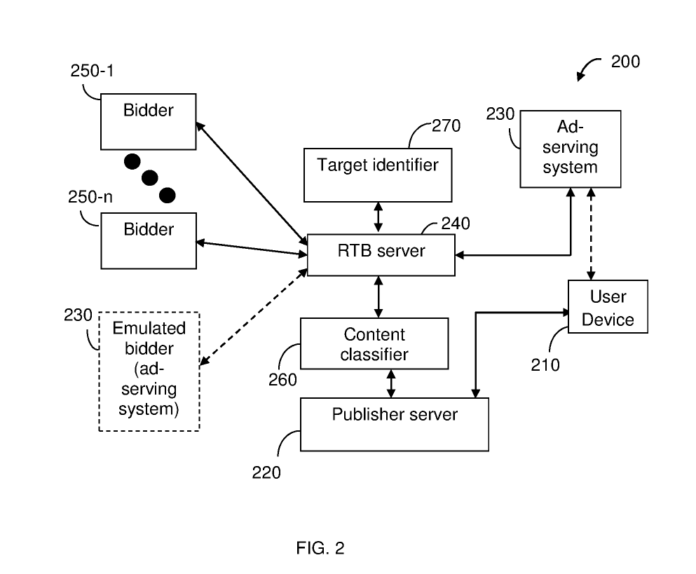

FIG. 2 shows an exemplary and non-limiting schematic diagram of a system 200 utilized to describe the disclosed various embodiments of targeted bidding. The system 200 includes a user device 210, a publisher server 220, an advertisement-serving (ad-serving) system 230, a RTB server (ad-exchange) 240, a plurality of bidders 250-1 through 250-n (hereinafter referred to collectively as bidders 250 and individually as a bidder 250), a content classifier 260, and a target identifier 270. The various elements shown in FIG. 2 are typically communicatively connected to a network such as, but not limited to, a wireless, cellular or wired network, a local area network (LAN), a wide area network (WAN), a metro area network (MAN), the Internet, the worldwide web (WWW), similar networks, and any combination thereof.

Each bidder 250 is a computing device operated by a bidding entity (e.g., an advertising agency, a trade desk, a demand-side platform, and so on) to place bids on ad-impressions and to provide the ad-serving system 230 with advertisements to be served. A user device 210 may be, for example, a personal computer (PC), a personal digital assistant (PDA), a mobile phone, a smart phone, a tablet computer, a laptop, and the like, having capabilities for downloading and displaying webpages. The publisher server 220 is a web-server hosting a website accessible through the user devices 210. It should be noted that only one user device 210 and one publisher server 220 are shown in FIG. 2 merely for the sake of simplicity of the description and without limitation on the disclosed embodiments.

The webpages provided by the publisher 220 may feature advertisements served by the ad-serving system 230. The advertisements being served by the ad-serving system 230 are selected for the bidder 250 that won a bid on a placement of an advertisement.

A bidding transaction begins with a user of a user device 210 visiting a website hosted by the publisher server 220, thereby requesting web content. The request (e.g., a HTTP request) from the user device 230 triggers a call via the publisher server 220 to the RTB server 240 for a bid request respective of an ad-impression that includes a URL associated with the visited website. As noted above, a request for a bid from the publisher server 220 typically includes a masked URL or fake URL that is not representative of the real web page visited by the device 110. Alternatively, the masked or fake URL may be provided by the RTB server 240. That is, the RTB server 240 typically provides the bidders 250 with a bid-ID that does not include the URL of the page in which the ad should be placed.

According to an embodiment, in order to allow at least targeted bidding via the bidders 250, the real URL and/or classification parameters of the visited web page, i.e., the webpage in which the advertisement is served, may be provided to the bidders 250. The real URL may be provided in real-time or immediately after the request to the web page is provided, thereby allowing the bidders 250 to generate educated or otherwise improved bidding decisions in real-time. Specifically, the provision of the real URL and classification parameters allows, e.g., for more accurate targeting of advertisements, thereby increasing advertising effectiveness. For example, providing URL information indicating that the web page is titled “football weekly roundup” may yield more accurately targeted advertisements than an indication that the web page is on a “sports” website. In another embodiment, the identification of the “real” URL can be used in one or more off-line processes to improve campaign verification and optimization. For example, information received from a serving company as to where the advertisement was actually served can be compared against one or more real URLs in which bidder 250 placed bids. According to the disclosed embodiments, identification of such real URLs is performed by the web page identifier 270.

Specifically, providing the “real” URL information may include determining the URL of the webpage being bid on and/or classifying the webpage based on semantic analysis thereof. The URL determination and webpage classification may be performed with the aid of the content classifier 260 and the ad-serving system 230. The content classifier 260 is configured to receive a URL of a requested web page (e.g., a masked or fake URL) and a bid identifier (bid-ID) from the RTB server 240.

The content classifier 260 is configured to semantically analyze the URL and to generate advertisement-related classification parameters associated with the URL. The classification parameters can be utilized in the bidding process for advertising in a webpage associated with the URL. The classification parameters typically relate to one or more categories of the webpage (addressed by the URL) that the page is associated with. Examples for such categories include, for example, news, sports, games, and so on. An exemplary implementation of such classifier is disclosed in U.S. patent application Ser. No. 12/973,541, now pending, assigned to the common assignee, which is hereby incorporated by reference for all that it contains.

In an embodiment, the classifier 260 may be configured to receive the real URL (as opposed to the masked URL) from the RTB server 240 and to send the real URL to the target identifier 270. Preferably, the classification parameters may also be provided to the target identifier 270. It should be noted that the classifier 260 is typically implemented within the RTB server 240 and, thus, the classifier 260 typically does not and cannot communicate directly with the advertisers 250. Any classification parameter generated by the classifier 260 may be provided to the advertisers 250 by the RTB server 240.

The target identifier 270 saves the bid-ID and its respective received real URL and/or classification parameters in a table. In an embodiment, the table is a hash table where the hash value is computed over the bid-ID. The table is saved in a memory (not shown in FIG. 2), such as a Flash memory or a SSD memory to allow fast retrieval of information. In an embodiment, the target identifier 270 may be configured to subsequently identify target information based on a bid-ID and the URLs and classification parameters saved in the table. The target information may be utilized to allow targeted bidding by identifying specific information related to content in the webpage. The target information may include the real URL and/or classification parameters associated with the webpage. The identification of the target information may be performed in real-time, before the advertiser places a bid, thereby requiring quick processing by the target identifier 270.

In one embodiment, to enable the identification of the URL, the ad-serving system 230 is emulated so as to operate as a potential bidder. As such, the ad-serving system 230 receives, from the RTB server 240, the bid-ID and optionally the classification parameters. It should be noted that the ad-serving system 230 may also be configured to serve advertisements (i.e., to place advertisements in webpages) by winning bidders of the bidders 250.

According to the disclosed embodiments, when the RTB server 240 requests for bids, the target identifier 270 identifies and communicates the real URL and/or classification parameters (of the visited webpages) to the bidders 250. To this end, the target identifier 270 requests the current bid-ID from the ad-serving system 230 (emulated as a bidder). The target identifier 270 is configured to match the current bid-ID against the table to retrieve the respective URL. In an embodiment, a hash function may be applied on the current bid-ID. It should be noted that the same hash function may be applied on the bid-ID when saving and when retrieving the respective matching URL.

In an embodiment, the target identifier 270 is not communicatively connected to the bidders 250. In such an embodiment, the real URL may be sent from the ad-serving system 230 to the bidders 250. It should be noted that, in both configurations (i.e., when URLs are provided by the system 230 or by the identifier 270), the identified URLs can be pushed to the bidders 250 together with or immediately after the bid-ID is provided by RTB server 240. Alternatively or collectively, the identified URL (which the real URL of the visited web-server) is provided upon request by one or more of the bidders 250.

It should be appreciated that providing the real URL of the visited webpage in real time, i.e. prior to bidding on an impression by the bidders 250, allows improved targeting of the displayed ads and the campaign. For example, in a bid-ID to a placement of an ad into the CNN.COM webpage, the bid-ID is accomplished by a classification parameter of “news”. The bidders 250 are not aware of the fact that the bid is for CNN.COM's webpage. The classification parameter of “news” may relate to other news websites, such FOXNEWS.COM or NEWYORKTIMES.COM. A bidder 250, according to the conventional approach, cannot distinguish between these websites prior to placing a bid. However, according to the disclosed embodiments, the URL on a webpage on which the bid should be placed is provided to the bidder. Thus, by implementing the disclosed embodiments, the bidders 250 can target their campaigns according to a specific website. For example, for news relates website advertiser bidder 250 can select to bid only impressions from FOXNEWS.COM.

It should be further noted that providing the real URL of the visited web page may also be useful outside of real time (e.g., post-bidding). Such real URL information may be used for reporting and/or verification by each bidder to confirm placement of appropriately targeted advertisements respective of webpages. Thus, after placement of an advertisement in a webpage for a winning bidder, the URL of the webpage in which the advertisement was placed may be provided to, e.g., the winning bidder. For example, the provided URL may be from a webpage on NFL.COM. This URL information may be important for reporting and/or verifying that the bid went to a football-related webpage or, specifically, to the NFL.

As noted above, the winning bidder among the bidders 250 is reported to the ad-serving system 230 by the RTB server 250 for the purpose of placing the advertisement in the visited webpage. In an embodiment, the ad-serving system 230 is configured to provide the information about the winning bidders to the target identifier 270. The target identifier 270 is configured to correlate the information about the winning bidder with the bid-ID and identified URL. The correlated information is saved in a verification report that can be utilized in a verification process.

According to the disclosed embodiments, the impression verification is performed post bidding on an ad-impression. The verification processes may include, but is not limited to, checking if the served impressions, as reported by the ad-serving system 230, match the information in the verification report as generated by the content classifier 260. That is, checking if a URL reported in a served ad-impression matches the identified URL in the respective bid-ID. The verification process may be performed by the content classifier 260 or by a third party verification server (not shown).

The verification report can be further utilized for campaign optimization. That is, advertisers can change their decisions to place ads in one web-site to another web-site. It should be noted that, although the processing of the verification report can be performed in real-time, changing the placement's decisions, and hence bidding decisions, cannot be performed in real-time.

In an embodiment, the target identifier 270 includes a processing unit 272 communicatively connected to a memory 274. In one implementation, the memory 274 contains instructions that, when executed by the processing unit 272, results in the performance of, but not limited to, the process for identifying URLs as described in detail herein above. In an embodiment, the memory 274 may further store the table and/or the verification reports.

In certain embodiments, the target identifier 270 is configured to identify the real URL on which a bid should be placed based on iFrame or JavaScript tags included in the visited webpage. As an example, an iFrame tag in an HTML page contains the following information:

<IFRAMESRC=“https://ad.servin.com/ddm/adi/Nzzzz.site-
keyname/Byyyyyyy;sz=widthxheight;ord=[timestamp];dc_lat=N;dc_rdid=Cxxxxxtag_for_{—}
child_directed_treatment=l;kw=[keyword];click=?” WIDTH=X HEIGHT=Y
&bid_id=12345&MARGINWIDTH=0 MARGINHEIGHT=0 HSPACE=0 VSPACE=0
FRAMEBORDER=0 SCROLLING=no BORDERCOLOR=‘#000000’>
</IFRAME>

As can be noted the URL of the source is masked (ttps://ad.servin.com/ddm/adi/Nzzzz.site-keyname/Byyyyyyy;sz=width×height;ord=[timestamp]). In an embodiment, in order to identify the real URL, the bid-ID is extracted from the iFrame tag (in the above example, bid_id=12345). The extracted bid-ID is provided to the target identifier 270 to match it against the table real URLs to retrieve the respective URL. In the embodiment, the processing of the iFrame tag is performed post serving.

It should be noted that the processing unit 272 may comprise or be a component of a processor (not shown) or an array of processors coupled to the memory 274. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing unit 272 may include machine-readable media for storing software. Software shall be construed broadly to mean instructions of any type, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein. In one configuration, the processing system may include one or more processors. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entity that can perform calculations or other manipulations of information.

It should be noted that various embodiments have been described herein with a specific reference that the content classifier 260 and the target identifier 270 are separate entities from the ad-serving system 230 and from the RTB server 240. However, in some implementations, the functionality of the content classifier 260 and/or the target identifier 270 may be integrated in the ad-serving system 230 and/or in the RTB server 240.

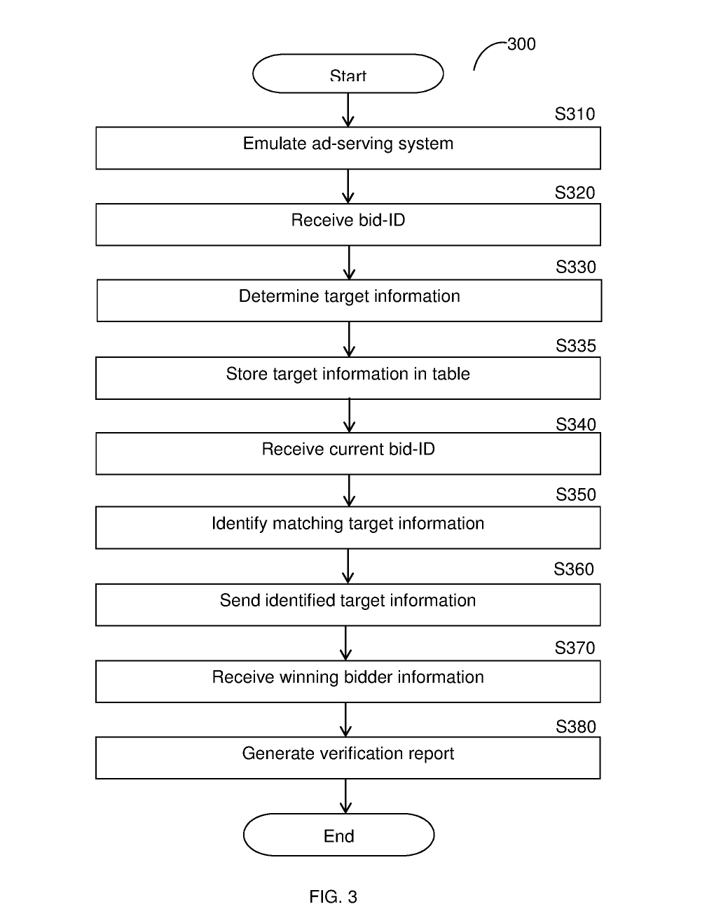

FIG. 3 is an exemplary and non-limiting flowchart 300 illustrating a method for allowing targeted bidding for on-line ads according to an embodiment. In an embodiment, the method of FIG. 3 may be performed by an RTB server (e.g., the RTB server 240). In an embodiment, the method may begin upon receiving a request for a bid. At S310, emulation of an ad-serving system is caused such that the ad-serving system acts as a bidder on an advertisement placement in a webpage. The emulation allows the ad-serving system to receive and provide bid-IDs associated with ad-impressions being bid on.

At S320, a bid-ID is received. The bid-ID is received in response to a request for a bid on an ad-impression that is triggered when a user visits a webpage of the publisher. The visited webpage is designated by a URL address (“real URL”). As noted above, the bid-ID sent to the advertisers does not include the real URL, and in most cases includes a masked URL (of the real URL) or does not include any URL.

At S330, a determination of target information of the webpage associated with the bid-ID is caused and the target information is received. The target information may be used to allow targeted bidding by providing information suggesting, for example, types of content in the webpage, and may include the real URL and/or classification parameters of the webpage. At S335, the received target information is stored in a table. In an embodiment, the table is a hash table, where the hash value is computed over the bid-ID.

At 340, a current bid-ID is received from the emulated bidder. At S350, the current bid-ID is compared against information stored in the table to identify target information associated with the bid-ID. The table indicates associations between bid-IDs and real URLs and/or classification parameters. In an embodiment, a hash value is computed against the received bid-ID to retrieve the real URL.

At S360, the identified target information is sent to bidders and/or advertisers prior to bid placement. The identified target information may be sent alongside other information related to the bid.

At optional S370, the winning bidder information may be received. The winning bidder information may be received from, e.g., an ad-serving system. The winning bidder information includes an identifier of an advertiser and/or bidder that won the bid and the respective bid-ID number.

At optional S380, the winning bidder information may be correlated with the information in the table to generate a verification report. The verification report may be saved for future execution of verification process.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that performs the same function, regardless of structure.

1. A method for allowing targeted bidding for online advertisements, comprising:
causing an emulation of a bidder bidding on a placement of an advertisement in a webpage;
receiving, from the emulated bidder, a current bid identifier associated with the placement;
causing, in real-time, a comparison of the current bid identifier to at least one stored bid identifier, wherein each stored bid identifier is associated with stored target information;
receiving target information for the webpage, wherein the received target information is identified based on the comparison, wherein the received target information characterizes the webpage; and
sending the received target information of the webpage to at least one other bidder that is bidding on the placement.

2. The method of claim 1, wherein the stored target information includes at least one of: a real web page identifier and classification parameters.

3. The method of claim 2, wherein the real webpage identifier is a uniform resource locator (URL).

4. The method of claim 2, wherein the stored target information is stored in a hash table, wherein identifying the received target information further includes computing a hash value against the current bid identifier.

5. The method of claim 1, wherein the received target information is determined based on a bid identifier associated with a previous placement of advertisements in the webpage.

6. The method of claim 1, wherein the emulated bidder is part of an advertisement-serving system.

7. The method of claim 1, further comprising:
receiving winning bidder information associated with the placement, wherein the winning bidder information identifies a winning bidder and a respective winning bid identifier.

8. The method of claim 7, further comprising:
correlating the winning bidder information with the received target information.

9. The method of claim 8, further comprising:
generating a verification report based on the correlated information.

10. A non-transitory computer readable medium having stored thereon instructions for causing one or more processing units to execute the method of:
causing an emulation of a bidder bidding on a placement of an advertisement in a webpage;
receiving, from the emulated bidder, a current bid identifier associated with the placement;
causing, in real-time, a comparison of the current bid identifier to at least one stored bid identifier, wherein each stored bid identifier is associated with stored target information;
receiving target information for the webpage, wherein the received target information is identified based on the comparison, wherein the received target information characterizes the webpage; and
sending the received target information of the webpage to at least one other bidder that is bidding on the placement.

11. A system for allowing targeted bidding for online advertisements, comprising:
a processing unit; and
a memory, the memory containing instructions that, when executed by the processing unit, configure the system to:
cause an emulation of a bidder bidding on a placement of an advertisement in a webpage;
receive, from the emulated bidder, a current bid identifier associated with the placement;
cause, in real-time, a comparison of the current bid identifier to at least one stored bid identifier, wherein each stored bid identifier is associated with stored target information;
receive target information of the webpage, wherein the received target information is identified based on the comparison, wherein the received target information characterizes the webpage; and
send received the target information of the webpage to at least one other bidder that is bidding on the placement.

12. The system of claim 11, wherein the stored target information includes at least one of: a real web page identifier and classification parameters.

13. The system of claim 12, wherein the real webpage identifier is a uniform resource locator (URL).

14. The system of claim 12, wherein the stored target information is stored in a hash table, wherein identifying the received target information further includes computing a hash value against the current bid identifier.

15. The system of claim 11, wherein the received target information is determined based on a bid identifier associated with a previous placement of advertisements in the webpage.

16. The system of claim 11, wherein the emulated bidder is part of an advertisement-serving system.

17. The system of claim 11, wherein the system is further configured to:
receive winning bidder information associated with the placement, wherein the winning bidder information identifies a winning bidder and a respective winning bid identifier.

18. The system of claim 17, wherein the system is further configured to:
correlate the winning bidder information with the received target information.

19. The system of claim 18, wherein the system is further configured to:
generate a verification report based on the correlated information.

20. (canceled)

21. (canceled)
